(19) United States
(12) Patent Application Publication
(10) Pub. No.: US 2026/0025284 A1
(43) Pub. Date: Jan. 22, 2026

(54) ENCLAVE ARCHITECTURE

(71) Applicant: The Blockhouse Technology Limited, Oxford (GB)

(72) Inventors: Pedro ANTONINO, Oxford (GB); Srdjan CAPKUN, Zürich (CH); Ante DEREK, Zagreb (HR); Tomislav HECIMOVIC, Zagreb (HR); Mario MATIJASEVIC, Samobor (HR); Vedran KRALJ, Zagreb (HR); Vedran NOVOSELAC, Beli Manastir (HR); Ivan VIDAKOVIC, Zagreb (HR)

(73) Assignee: The Blockhouse Technology Limited, Oxford (GB)

(21) Appl. No.: 19/107,153

(22) PCT Filed: Aug. 31, 2023
(86) PCT No.: PCT/GB2023/052263

§ 371 Date: Feb. 27, 2025

(30) Foreign Application Priority Data
Sep. 6, 2022 (GB) 2213012.4

(51) Int. Cl. H04L 9/32

(52) U.S. Cl. CPC H04L 9/3268; H04L 9/321

(57) ABSTRACT

A method of operating a computer system (2) to manage a set of enrolled service enclaves (6a, 6b, 6c, 6d, 6e, 6f) includes enrolling a new service enclave (10) into the set of enrolled service enclaves. An authority service (6b), hosted on a first computing device (4b), receives an identifier (14) of a second computing device (12), which hosts the new service enclave (10). The authority service (6b) uses the identifier (14) to receive, from the second computing device (12), an attestation (16) of software code stored in the new service enclave (10). In response, the authority service (6b) generates a certificate associating the identifier (14) with a public key of the new service enclave (10) and provides the certificate to an already-enrolled service enclave (6a, 6c, 6d, 6e, 6f).

### BACKGROUND OF THE INVENTION

This invention relates to a secure computer system and methods of operating the same.

Microservice architectures can be used to enable the manageable provision of a service or services using a networked computer-system architecture comprising a plurality of independent, self-contained components (e.g. having independent processors and/or software applications), each having a well-defined role and interface.

Advantageously, owing to the modular nature of the components, microservice architectures can be rolled out, operated, updated and scaled (e.g. by enrolling new service components) relatively straightforwardly in comparison to monolithic architectural approaches. Components of the microservice architectures may also be spatially distributed, and such microservice architectures can also be particularly suitable for deployment in cloud-based applications, where they can provide good responsiveness and high resilience to faults.

Although each component of a microservice architecture may operate substantially independently, there is often a need for components to communicate with each other, e.g. to instruct the performance of one or more tasks or to share data to be processed.

However, the division of responsibility for providing services and the requirement for multiple communication channels between components means that ensuring the security of a microservices system can be challenging. Users of conventional microservice architectures may be required to trust the provider of the architecture that the components are operating as expected (e.g. non-maliciously), and it may be difficult or impossible to determine that this trust is well-placed.

The applicant has identified that, in order to increase the security of microservice architectures, it would desirable for such systems to be more transparently trustworthy.

Embodiments of the present invention seek to address this challenge.

### SUMMARY OF THE INVENTION

From a first aspect, the invention provides a method of operating a computing system to manage a set of enrolled service enclaves, wherein the system comprises:
a network of computing devices;
a plurality of service enclaves hosted on one or more of the computing devices of the network; and
an authority service hosted on a first computing device of the network;
the method comprising enrolling a new service enclave of the plurality of service enclaves, hosted on a second computing device of the network, into the set of enrolled service enclaves by:
the authority service receiving an identifier of the second computing device hosting the new service enclave;
the authority service using the identifier of the second computing device to receive, from the second computing device, an attestation of software code stored in the new service enclave;
in response to receiving the attestation, the authority service generating a certificate that associates the identifier of the second computing device with a public key of the new service enclave; and
the authority service providing the certificate to an already-enrolled service enclave of the plurality of service enclaves.

When viewed from a further aspect, the invention provides a computer system comprising an authority service hosted on a first computing device and configured to enrol a new service enclave, of a plurality of service enclaves hosted on one or more computing devices of a network of computing devices, into a set of enrolled service enclaves by:
receiving an identifier of a second computing device, of the network, hosting the new service enclave;
using the identifier of the second computing device to receive, from the second computing device, an attestation of software code stored in the new service enclave;
in response to receiving the attestation, generating a certificate that associates the identifier of the second computing device with a public key of the new service enclave; and
providing the certificate to an already-enrolled service enclave of the plurality of service enclaves.

When viewed from a further aspect, the invention provides computer software which, when executed on a first computing device of a network of computing devices, causes the first computing device to host an authority service configured to enrol a new service enclave, of a plurality of service enclaves hosted on one or more of the computing devices of the network, into a set of enrolled service enclaves by:
receiving an identifier of a second computing device, of the network, hosting the new service enclave;
using the identifier of the second computing device to receive, from the second computing device, an attestation of software code stored in the new service enclave;
in response to receiving the attestation, generating a certificate that associates the identifier of the second computing device with a public key of the new service enclave; and
providing the certificate to an already-enrolled service enclave of the plurality of service enclaves.

Thus it will be seen that, in accordance with embodiments of the invention, certification by the authority service binds a public key of an attested new service enclave to the identifier of the computing device hosting the new enclave. This allows existing service enclaves to trust the new service enclave and to communicate securely with it through the computing device that hosts it.

The authority service can therefore act as a single point of trust to help satisfy users that the system as a whole, i.e. each of the plurality of service enclaves, is configured to operate as intended. This means that users are not required to verify directly the configuration of each of the service enclaves (although they may still do so if they wish in some embodiments), but can instead verify the trustworthiness of the authority service. The authority service may be configured to prove that it is running trusted software code (e.g. that has been independently certified as secure), which can help the user to be confident that the authority service is trustworthy and is appropriately certifying the service enclaves of the system. For example, the software run by the authority service may be open source and/or may be audited by an independent authority.

Allowing a user to place its trust in only a single authority, rather than a plurality of service enclaves, permits the system to be scaled up without imposing any additional burden on the user. Rather, as long as the user can trust that the authority service is operating as intended, the system can be scaled to include any number of enclaves. This microservices architecture also allows the software of the service enclaves to be updated without requiring the user to reassess whether the updated enclaves can be trusted.

Each computing device may be a respective server or workstation. It may have a respective independent connection to the network. Each may comprise a memory and a processor configured to provide a trusted execution environment (TEE). Each may be configured to securely decrypt and execute software instructions that are stored, encrypted, in an enclave of the device. Each may store one or more enclave-specific cryptographic key pairs.

In some embodiments, the computer system comprises the one or more computing devices hosting the plurality of service enclaves. Each of the plurality of service enclaves is preferably a trusted execution environment (TEE) enclave. The TEE enclave may be provided by an Intel processor that supports Software Guard Extensions (SGX), or an Arm processor that supports TrustZone, or any other processor configured to provide a TEE.

Each computing device of the network of computing devices is preferably configured to establish an encrypted and authenticated channel with one or more other computing devices of the network of computing devices—e.g. a Transport Layer Security (TLS) network connection. The first computing device is preferably configured to establish an encrypted and authenticated channel (e.g. a TLS connection) with the second computing device. The first computing device may further be configured to establish an encrypted and authenticated channel (e.g. a TLS connection) with one or more other computing devices of the network of computing devices.

The authority service may be provided by an authority enclave hosted on the first computing device. The authority service may be configured to provide the certificate over any communication channel. The authority service may be configured to provide the certificate to the already-enrolled service enclave directly. However, the authority service may be configured to provide the certificate to the already-enrolled service enclave via one or more intermediary devices. The authority service may provide the certificate to a plurality or to all of the already-enrolled service enclaves of the plurality of service enclaves (i.e. those service enclaves that are in the set of enrolled service enclaves when the certificate is generated).

The authority service is preferably associated with a unique key pair, comprising a public key and a private key. Each of the enrolled service enclaves is preferably associated with a unique key pair. Preferably the public key of each enclave is known to one or more (e.g. all) of the enrolled service enclaves and the authority service. It will be appreciated that a communication signed using the private key of a key pair can be verified using the public key as having been signed by the owner of said private key. The use of key pairs in this way can facilitate the verification of the source of communications between enclaves, thereby helping to improve the security of the system.

Preferably the authority service is configured to sign the certificate using the private key of the key pair associated with the authority service. Each of the already-enrolled service enclaves that receives the certificate may be configured to use a public key of the authority service to authenticate the certificate. As explained above, this allows the already-enrolled service enclaves to verify the origin of the certificate.

The authority service may be configured to enforce one or more policies for the system. The one or more policies may comprise a maximum number of service enclaves that may be enrolled at a time. The one or more policies may be defined by policy data stored in the system. In some embodiments the policy data is stored in the first computing device. In some embodiments the policy data is stored in the database of the network. The policy data may static. However, in some embodiments the policy data is dynamically configurable, e.g. by an administrator.

In some embodiments, (e.g. after having received the certificate) each of the already-enrolled service enclaves is configured to use the public key of the new service enclave to send encrypted data to the new service enclave. Preferably, each already-enrolled service enclave is permitted to communicate with the new service enclave only after receiving (e.g. and authenticating) the certificate generated by the authority service. This helps to ensure that enrolled enclaves are able to communicate with a new enclave only once the authority service has confirmed (by issuing the certificate) that the new enclave is operating as intended and is therefore likely to be secure.

In some embodiments, the new service enclave is configured to generate an attestation report. The attestation report may comprise a hash of the software code that is stored in the new service enclave. The attestation report preferably includes the public key of the new service enclave and/or the public key of the authority service.

Each computing device of the network of computing devices may have a respective identifier. The identifier of the second computing device (and/or of each computing device) may comprise any suitable identifier that is unique within the system. The identifier may comprise a network address of the computing device. The identifier may comprise a processor ID.

Preferably, the already-enrolled service enclave (or each of the enrolled service enclaves) is configured to store configuration data. The configuration data may comprise a respective identifier for each of the plurality of enrolled service enclaves.

In some embodiments, the configuration data comprises one or more communication rules. Preferably the (e.g. communication rules of the) configuration data indicates whether a first type of service enclave is authorised to communicate with a second type of service enclave. The already-enrolled service enclave (or each of the enrolled service enclaves) is preferably configured to use the (e.g. communication rules of the) configuration data to determine whether to receive and process a communication from another service enclave. This can provide an additional layer of restriction on the communication between enclaves, thereby helping to further improve the security of the system. For example, the communication rules may restrict communication between devices to those having network addresses all within a single country or organisation.

In some embodiments, the configuration data comprises a database-access password for accessing a database of the network. The database may comprise information relating to a digital identity of one or more users of the computing system. The digital identity may comprise an email address or the name of an internet account associated with the user. A user may be associated with a plurality of digital identities. As discussed below, this can allow a user to interact with the computing system using an account that is associated with an established digital identity, which is itself associated with the user, rather than requiring the user to create a new digital identity for use with the computing system. This can help to reduce the anonymity of users, thereby increasing their accountability for their interactions with the system, which can increase the security of the system as a whole.

Preferably the authority service is configured to store configuration data. In some embodiments the configuration data comprises policy data defining one or more policies that the authority service is configured to enforce, e.g. as discussed above. In some embodiments, the authority service is configured to provide the configuration data to the new service enclave. The authority service is preferably configured to provide the configuration data to the new service enclave only after generating the certificate. This helps to ensure that only service enclaves that have been attested and therefore enrolled by the authority service are allowed to access the configuration data for the system.

In some embodiments, the configuration data comprises expected measurement data for verifying an attestation of one or more already-enrolled enclaves of the network. The attestation may comprise a hash of software code stored in the or each already-enrolled service enclave(s). The expected measurement data may comprise a pre-configured hash of software code that the already-enrolled service enclave is expected to be storing. Preferably the new service enclave is configured to use the expected measurement data to attest one or more already-enrolled enclaves of the network. In some embodiments, the new service enclave is configured to compare the hash of software code stored in the already-enrolled service enclave with the expected measurement data corresponding to said already-enrolled service enclave.

The configuration data is preferably signed by a certifying authority. The certifying authority may, in some embodiments, be regarded as part of the computing system disclosed herein, or it may be separate. Preferably the certifying authority is associated with a key pair comprising a private key and a public key. The configuration data may be signed using a private key of the certifying authority. In some embodiments, the new service enclave is configured to use the public key of the certifying authority to authenticate the configuration data. The certifying authority is preferably off-line, i.e. is not communicatively connected to the network of computing devices. The off-line certifying authority is preferably air-gapped from the network of computing devices. The configuration data may be communicated to the authority service by a non-network channel (e.g. by the movement of a physical storage medium).

Each of the enrolled service enclaves may be configured to receive new software code for executing in the enrolled service enclave. This allows the software running in each of the service enclaves to be updated. Preferably, the new software code is signed using a private key of the certifying authority. Preferably, the already enrolled service enclave (or each of the enrolled service enclaves) is configured to use the public key of the certifying authority to authenticate new software code before executing the new software code in the already-enrolled service enclave. It will be appreciated that this allows enrolled service enclaves to verify the origin of software code before it is executed, thereby helping to increase the security of the system.

In some embodiments, the authority service is configured to provide the certificate to only a subset of the plurality of service enclaves. The authority service may be configured to identify the subset of the plurality of service enclaves using one or more communication rules stored by the authority service. As discussed above, each already-enrolled service enclave is preferably permitted to communicate with the new service enclave only after receiving (and preferably authenticating) the certificate generated by the authority service. In such embodiments, the communication rules can be enforced by withholding the certificate associated with a new service enclave from subset of service enclaves with which it is not permitted to communicate. The communication rules may be stored in configuration data stored by the authority service.

The authority service is preferably configured to attest itself to the new service enclave (e.g. before enrolling the new service enclave). Thus, preferably the new service enclave is configured to receive, from the authority service, an attestation of software code stored in the authority service.

The computer system preferably further comprises a gateway enclave. It may be hosted by a gateway computing device of the network. The gateway enclave is preferably arranged to provide an access point for a user of the system, e.g. so that users can interact with the gateway enclave to instruct (via the gateway enclave) the service enclaves to perform one or more services for or on behalf of the users. Preferably the gateway enclave is the only enclave of the computing system with which a user can interact (i.e. directly). In some embodiments, the gateway computing device may be the only computing device of the network that has a public network address, e.g. that has a public IP address on the Internet.

The gateway enclave is preferably configured to receive, and/or send to a client computing device, an attestation for the authority service. It may also be configured to receive, and/or send to the client computing device, an attestation for each of the set of enrolled service enclaves. This allows the user to receive an attestation of the system as a whole via the gateway enclave. The authority service can itself certify to the user that each of the enrolled service enclaves are trusted; however, it will be appreciated that some embodiments may provide a further level of confidence by each of the enrolled service enclaves being configured to send a respective attestation to the user (via the gateway enclave), e.g. in addition to the attestation provided by each service enclave to the authority service during its enrolment.

The gateway enclave is preferably configured to receive a service request from the client computing device. The service request may be a request for one or more of the service enclaves to perform a service. Preferably, in response to receiving a request, the gateway enclave is configured to instruct an already-enrolled enclave to perform the requested service.

In some embodiments, the system comprises the client computing device. The client computing device may comprise a smartphone, tablet or personal computer.

In some embodiments, the gateway enclave is configured to receive an attestation of the client computing device. The gateway enclave is preferably configured to receive the attestation from the client computing device. The gateway enclave may be configured to verify the attestation of the client computing device. Preferably the gateway enclave is configured to verify the attestation of the client computing device before instructing the already-enrolled enclave to perform the requested service. The gateway enclave may be configured to ignore the service request in response to failing to verify the attestation of the client computing device.

In some embodiments, the client computing device is configured to receive an attestation of the gateway enclave. The client computing device is preferably configured to receive the attestation from the gateway enclave. The client computing device is preferably configured to verify the attestation of the gateway enclave.

The gateway enclave and the authority service may be hosted on separate computing devices. However, in some embodiments, both the authority service and the gateway enclave are hosted on the first computing device. This can help to improve the ease with which the authority service and the gateway enclave are implemented.

In some embodiments, the computing system comprises an account manager service enclave. The account manager service enclave may be configured to generate a binding between an account certificate for a user of the system and digital identity data corresponding to the user. The gateway enclave may be configured to verify the account certificate of a user in response to receiving a service request from the user. The gateway enclave may be configured to compare an account certificate provided by a user with a whitelist of account certificates stored in the configuration data to determine whether the to process the service request.

In some embodiments, the computing system comprises a signer enclave. The signer enclave may be configured to bind the account certificate of a user with a cryptocurrency wallet. The signer enclave is preferable configured to bind the account certificate of the user with a cryptographic transaction-signing key pair. In some embodiments, the computing system comprises a key vault enclave configured to store the cryptographic transaction-signing key pair of the user. The signer enclave is preferably configured to sign cryptocurrency transactions on behalf of the user. The signer enclave is preferably configured to sign transactions on behalf of the user in accordance with one or more transaction-signing policies associated with the user.

Preferably at least two of the computing devices of the network have different respective processor architectures and/or computer architectures (e.g. different hardware and/or operating systems). Each processor or computing system may be manufactured by a different respective manufacturer, such as Intel Corporation™ Arm Limited™ and/or may be provided or operated by a different respective operator, e.g. Amazon Web Services (AWS)™, etc. This can help to provide more robustness and protection from attack, such as side-channel attacks, as the likelihood of a single type of attack being successful against every computing device can be significantly reduced, owing to the variations in processor architectures.

Any enclave that receives an attestation from another enclave will preferably verify the received attestation (e.g. using an appropriate public key), and will enter and/or signal an error state if the verification fails.

Features of any aspect or embodiment described herein may, wherever appropriate, be applied to any other aspect or embodiment described herein.

Where reference is made to different embodiments or sets of embodiments, it should be understood that these are not necessarily distinct but may overlap.

### BRIEF DESCRIPTION OF DRAWINGS

Certain embodiments of the invention will now be described, by way of example only, with reference to the accompanying drawings, in which:

FIG. 1 is a schematic diagram of a computing system, and a user thereof, in accordance with an embodiment of the present invention;

FIG. 2 is a schematic diagram of a computing apparatus for use in embodiments of the invention; and

FIG. 3 is a flowchart of an enrolment of a new service enclave in accordance with an embodiment of the present invention.

### DETAILED DESCRIPTION

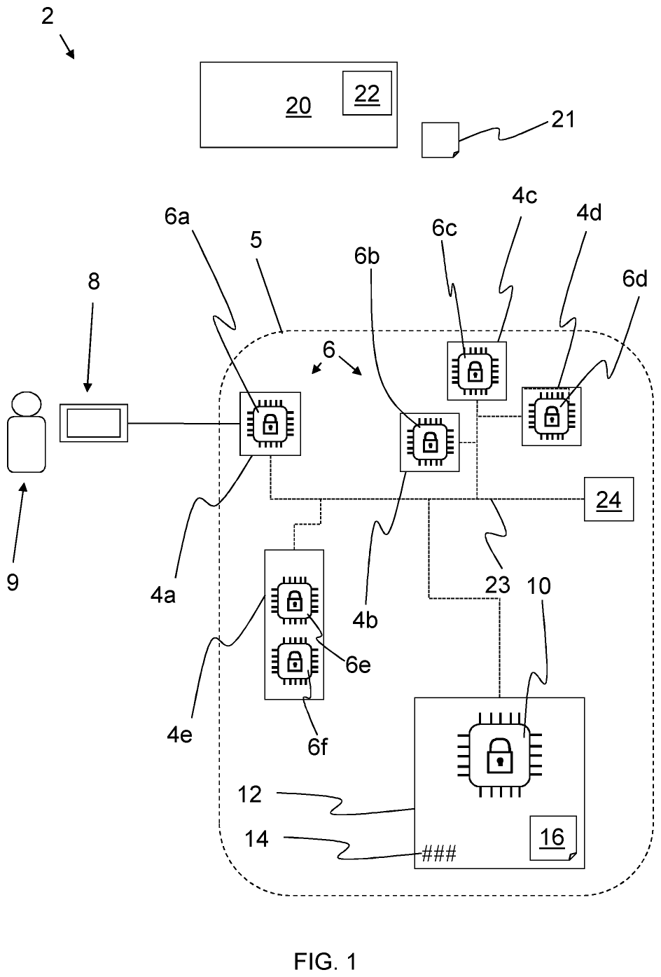

FIG. 1 shows a computing system 2 in accordance with an embodiment of the present invention.

The system 2 comprises a network 5 of computing devices 4a, 4b, 4c, 4d, each configured to host at least one respective trusted execution environment (TEE) enclave 6a, 6b, 6c, 6d, 6e, 6f. Each TEE enclave 6a-6f is configured to run software code in order to provide a respective service of a set of microservices. The TEE enclaves 6a-6f together form a set of enrolled service enclaves 6. The TEE enclaves 6a-6f each store an enclave-specific cryptographic key pair and are each configured to generate an attestation report to attest the respective software code they are running.

The network 5 may provide any number of wired and/or wireless communication channels 23 between the computing devices 4a, 4b, 4c, 4d, and optionally with further computer devices (e.g. the computing device 12). The network 5 may be a private physical network or it may be provided at least in part through the Internet (e.g. as a virtual private network). Each device has a unique network address on the network 5 (e.g. a unique MAC address and/or IP address).

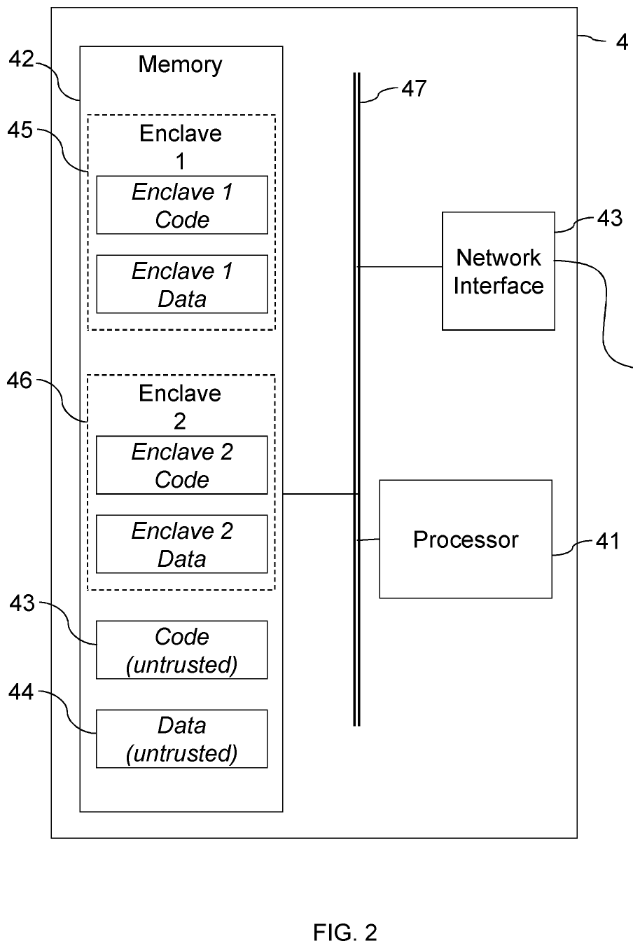

FIG. 2 shows an exemplary computing device 4 that could be used in the system 2 (e.g. as any of the computing devices 4a, 4b, 4c, 4d). It may be a server (e.g. a computer located in a server farm). It has a processor 41 which is connected to a memory 42 (e.g. DRAM) and to a network interface 43 by bus system 47. The processor 41 supports a trusted execution environment (TEE). It may implement Intel Software Guard Extensions (SGX) or Arm TrustZone. In addition to supporting conventional untrusted software code 43, and associated data 44, stored in the memory 42, the processor 41 also has hardware mechanisms to support a secure boot process, remote attestation, and for secure execution of code stored encrypted in one or more enclaves 45, 46 within the memory 42. Each enclave 45, 46 is a region of memory 42 storing encrypted code and associated encrypted data, which travels over the bus 47 in encrypted form, and is only ever decrypted within the processor 41. The integrity of the data and software in an enclave can be verified at boot time, e.g. using public-key-infrastructure (PKI) mechanisms, and the TEE can protect the code and data of each enclave 45, 46 from malicious or inadvertent compromise or attack. The network interface 43 may be communicatively coupled to a local area network (LAN) and/or a wide area network (WAN) including the Internet. The device 4 may be configured for encrypted and authenticated communications with other devices of the system 2 through the network interface 43—e.g. using Transport Layer Security (TLS).

Referring back to FIG. 1, a frontend gateway device 4a of the network 5 of computing devices 4a, 4b, 4c, 4d is configured to communicate with entities that are external to the system 2, such as an exemplary client device 8 shown in FIG. 1, which may be a smartphone, tablet or personal computer. This communication may occur over the Internet. The frontend gateway device 4a is the only device 4a of the network 5 of computing devices 4a, 4b, 4c, 4d that is able to communicate directly with external entities such as the client device 8. A user 9 can use an application running on the client device 8 to send a request to one or more of the service enclaves 6, via the gateway device 4a, to perform a service of the set of microservices. The frontend gateway device 4a is configured to host a frontend gateway enclave 6a.

The client device 8 can verify an attestation of the software code of the frontend gateway enclave 6a in order to guarantee to the user 9 that the frontend gateway enclave 6a is executing the correct (i.e. expected) code. The frontend gateway enclave 6a verifies attestations of the other already-enrolled service enclaves 6 (i.e. that they are securely booted and executing expected software code) and can therefore confirm to the user 9 that the system 2 is in an expected state, i.e. that the frontend gateway enclave 6a and all of the other enrolled service enclaves 6 are in the correct state and are running the expected software code. Thus, the whole system 2 is effectively and conveniently attested to the user 9 through the frontend gateway device 4a.

An authority service device 4b of the network 5 of computing devices 4a, 4b, 4c, 4d is configured to host an authority service enclave 6b. The authority service enclave 6b has an associated public and private key pair, the public key of which is known to all of the enclaves 6 and users 9 of the system 2.

The role of the authority service enclave 6b is to enrol new service enclaves into the set of enrolled service enclaves 6 in a trusted manner. The authority service enclave 6b enrols new service enclaves and generates certificates to assure the other enrolled enclaves 6, including the frontend gateway enclave 6a, of the identity and trustworthiness of the new service enclave. In this way, the authority service enclave 6b can ensure the continued trustworthiness of the microservice system 2 as a whole, even as new service enclaves are added to it.

FIG. 1 shows an exemplary new service enclave 10 that is to be enrolled in the set of enrolled service enclaves 6. It may provide a same microservice as one of the already-enrolled service enclaves 6 (e.g. so as to provide greater resilience to the network 5 in case of hardware failure, or to provide better geographical coverage for the set of microservices provided by the system 2), or it may provide a newer version of an existing type of microservice, or it may provide an entirely new type of microservice within the set of microservices. The enrolment process is described in more detail below, with reference to FIG. 2. The new service enclave 10 is hosted on a computing device 12 (which may be a computing device 4 as shown in FIG. 2) which is accessible through the network 5 via a unique network address 14. The new service enclave 10 stores a unique private and public key pair, and is configured to generate an attestation report 16 to attest the software code stored in the new service enclave 10.

The authority service enclave 6b acts as a single point of trust for the user 9, meaning that the user 9 is not required to verify directly the operation of each of the service enclaves 6. Instead, as service enclaves 6 must be certified by the authority service enclave 6b before they are permitted to communicate with other service enclaves 6 (and hence become part of the system 2), the user 9 may effectively delegate the burden of ensuring the correct operation of each of the enclaves 6 to the authority service enclave 6b. By certifying that each of the service enclaves 6 is operating as intended, the operation and security of the system 2 as a whole can be established by the user 9 by virtue of the trustworthiness of the authority service enclave 6b, which can be demonstrated to the user through the attestation of the frontend gateway enclave 6a.

The authority service enclave 6b runs software code that can be audited by the user 9 or by an independent auditing authority, which can help the user 9 to ensure that the authority service enclave 6b is appropriately certifying the service enclaves 6 of the system 2.

The authority service enclave 6b is also configured to communicate with an off-line certifying authority (CA) 20 that stores configuration data 22 for the system 2.

The off-line certifying authority 20 has an associated CA private-public key pair, the public key of which is provided out-of-band to the user 9. The CA public key is also stored in each of the already-enrolled enclaves 6. The CA private key is known only to the off-line certifying authority (CA) 20.

The configuration data 22 includes the network addresses of each of the computing devices 4a, 4b, 4c, 4d enrolled in the system 2. The configuration data 22 is signed using the CA private key, meaning that each of the already-enrolled enclaves 6 can use the CA public key to authenticate the configuration data 22.

The authority service enclave 6b receives the configuration data 22 from the off-line certifying authority 20 in an offline communication 21 (e.g. on a portable USB memory device that is physically transported to the authority service device 4b by an engineer). Once the authority service enclave 6b has received the configuration data 22 and is connected to the network 5, the authority service enclave 6b sends the configuration data 22 to each of the already-enrolled service enclaves 6. Each of the already-enrolled service enclaves 6 uses the CA public key to authenticate the configuration data 22.

The configuration data 22 further includes communication rules indicating which of the already-enrolled service enclaves 6 are permitted to communicate with which others of the already-enrolled service enclaves 6. As discussed below, already-enrolled service enclaves 6 (other than the authority enclave 6b) are generally prevented from communicating with non-enrolled enclaves such as the new service enclave 10. However, the communication rules of the configuration data 22 provide an additional layer of restriction on the communication between enclaves, thereby helping to further improve the security of the system 2.

Upon receiving a communication from a source already-enrolled service enclave, a recipient already-enrolled service enclave 6 uses the communication rules stored in the configuration data 22 to determine whether to process the communication. If communication with the source service enclave is prohibited for the recipient service enclave by the communication rules of the configuration data 22, the communication is ignored.

The system 2 further comprises a database 24 (e.g. a dedicated database server of the network 5) that is accessible by the already-enrolled service enclaves 6 using a network address of the database 24 and a database-access password. The network address of the database 24 and the database-access password are stored in the configuration data 22.

The database 24 can store data for the system 2 as a whole and also for each user 9 and/or client device 8 that interacts with the system 2. The database 24 also stores policy data that is accessible by the authority service enclave 6b. The policy data is configurable by an administrator of the system 2 and defines one or more policies that the authority service 6b enforces, including a maximum number of service enclaves 6 that can be enrolled in the system 2 at a time. The data stored on the database 24 may change and/or grow over time.

The configuration data 22 further includes, for each of the already-enrolled service enclaves 6, a pre-configured hash of the respective software code that the respective already-enrolled service enclave 6 is expected to be storing.

The network 5 of computing devices 4a, 4b, 4c, 4d further comprises an account manager device 4c, which hosts an account manager enclave 6c. The purpose of the account manager enclave 6c is to enrol users 9 by issuing account certificates, signed using a private key of the account manager enclave 6c.

The configuration data 22 comprises a whitelist of account certificates identifying users 9 that have been enrolled by the account manager enclave 6c and are therefore authorised to request that services be performed by the service enclaves 6.

In order to connect to the frontend gateway enclave 6a, users 9 are required to present their account certificate (e.g. which may be stored on a personal device 8 of the user 9), which is checked by the frontend gateway enclave 6a using the whitelist stored in the configuration data 22.

The account manager enclave 6c also stores a binding between the account certificate of each user 9 and corresponding digital identity data, which may include details of one or more of the user's 9 Internet accounts (e.g. email or social media). The digital identity data is stored in the database 24 of the system 2 and is accessible by the account manager enclave 6c only. The bindings are stored by the account manager enclave 6c and are accessible and modifiable only by the account manager enclave 6c.

The network 5 further comprises a signer device 4d, which hosts a signer enclave 6d. The signer enclave 6d binds the account certificate of each user 9 with a respective cryptocurrency wallet, and is responsible for storing and managing the cryptocurrency wallets of users 9, including signing transactions on behalf of the user 9 in accordance with stored transaction-signing policies. Respective transaction-signing policies are particular to, and associated with, the account certificate of each user. The signer enclave 6d also stores a respective management policy for each wallet, which defines how the transaction-signing policies are permitted to be updated.

Other service enclaves 6e, 6f, 10 may provide any desired microservices to users 9 of the system. These microservices may interact or cooperate with each other and/or with the signing service of the signed enclave 6d, e.g. to provide one larger service offering. However, in some embodiments, the set of microservices provided by the system 2 includes some disparate services.

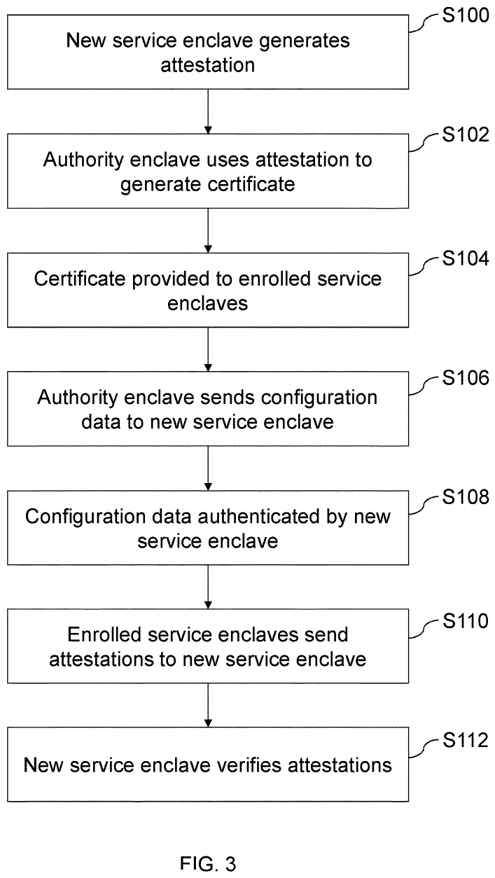

FIG. 3 shows a flowchart of the enrolment of the new service enclave 10 by the authority service enclave 6b, in accordance with an embodiment of the present invention.

In a first step S100, the new service enclave 10 generates an attestation report 16 that attests the software stored in the new service enclave 10. The computing device 12 hosting the new service enclave 10 establishes a TLS connection with the authority service device 4b and then sends the attestation report 16 over the network 5 to the authority service enclave 6b. The attestation report 16 is signed by the new service enclave 10 using the private key of the new service enclave 10. The attestation report 16 includes the public key of the new service enclave 10.

The authority service enclave 6b receives the attestation report 16 from the network address 14 of the device 12. The authority service enclave 6b may be required to provide the new service enclave 10 with an attestation of the software code running on the authority service enclave 6b, e.g. as a preliminary step in order to receive the attestation report 16 from the new service enclave 10.

In step S102, in response to receiving the attestation report 16, the authority service enclave 6b verifies the attestation report 16 and generates a certificate that associates the public key of the new service enclave 10 with the network address 14 of the device 12. The certificate 18 is signed using the private key of the authority service enclave 6b and is provided by the authority service enclave 6b to each of the other already-enrolled service enclaves 6 (step S104).

After receiving the certificate, the already-enrolled service enclaves 6 use the public key of the authority service enclave 6b to authenticate the certificate 18. If the authentication is successful, the already-enrolled service enclaves 6 can trust the new service enclave 10, and thereafter use the public key of the new service enclave 10 and the network address 14 of the device 12 to exchange encrypted data with the new service enclave 10. Otherwise, if no successful authentication has occurred, then the already-enrolled service enclaves 6 are prevented from communicating with the new service enclave 10. This helps to ensure that only properly authenticated enclaves are permitted to interact with the enrolled service enclaves 6, thereby improving the security of the system 2.

In step S106, the authority enclave 6b sends the configuration data 22 for the system 2 to the new service enclave 10. In step S108, the new service enclave 10 authenticates the configuration data 22 using the public key of the off-line certifying authority 20, which is pre-stored in the memory of the new service enclave 10.

In step S108, each of the other already-enrolled service enclaves 6 uses the network address 14 of the device 12 to send a respective attestation to the new service enclave 10, wherein the attestation comprises a hash of the software code that the respective already-enrolled service enclave 6 is executing.

In response to receiving each attestation, the new service enclave 10 compares the received hash with the corresponding hash of expected software code stored in the configuration data 22 to verify each of the received attestations (step S112). This allows the new service enclave 10 to verify that each of the already-enrolled service enclaves 6 is operating as intended, thereby further increasing the security of the system 2.

In this way, the system 2 can be expanded efficiently while still allowing the user 9 to have trust in the system 2.

It will be appreciated by those skilled in the art that the invention has been illustrated by describing one or more specific embodiments thereof, but is not limited to these embodiments; many variations and modifications are possible, within the scope of the accompanying claims.

1. A method of operating a computing system to manage a set of enrolled service enclaves, wherein the system comprises:
a network of computing devices;
a plurality of service enclaves hosted on one or more of the computing devices of the network; and
an authority service hosted on a first computing device of the network;
the method comprising enrolling a new service enclave of the plurality of service enclaves, hosted on a second computing device of the network, into the set of enrolled service enclaves by:
the authority service receiving an identifier of the second computing device hosting the new service enclave;
the authority service using the identifier of the second computing device to receive, from the second computing device, an attestation of software code stored in the new service enclave;
in response to receiving the attestation, the authority service generating a certificate that associates the identifier of the second computing device with a public key of the new service enclave; and
the authority service providing the certificate to an already-enrolled service enclave of the plurality of service enclaves.

2. The method of claim 1, further comprising:
the already-enrolled service enclave using a public key of the authority service to authenticate the certificate; and
the already-enrolled service enclave using the public key of the new service enclave to send encrypted data to the new service enclave.

3. The method of claim 1, comprising the new service enclave generating an attestation report that includes the public key of the new service enclave and/or a public key of the authority service.

4. (canceled)

5. The method of claim 1, wherein the already-enrolled service enclave is permitted to communicate with the new service enclave only after receiving and authenticating the certificate generated by the authority service.

6. The method of claim 1, comprising the authority service providing the certificate to only a subset of the plurality of service enclaves.

7. The method of claim 1, wherein the authority service is provided by an authority enclave hosted on the first computing device, the method further comprising the new service enclave receiving, from the authority service, an attestation of software code stored in the authority service.

8. The method of claim 1, comprising:
the already-enrolled service enclave storing configuration data; and
the authority service providing the configuration data to the new service enclave.

9. The method of claim 8, wherein the configuration data comprises a respective identifier for each of the plurality of service enclaves.

10. The method of claim 8, wherein the configuration data indicates whether a first type of service enclave is authorised to communicate with a second type of service enclave, and the method further comprises the already-enrolled service enclave using the configuration data to determine whether to receive and process a communication from another service enclave.

11. The method of claim 8, wherein the configuration data comprises expected measurement data for verifying an attestation of one or more already-enrolled enclaves of the network.

12. (canceled)

13. The method of claim 11, further comprising the new service enclave using the expected measurement data to attest one or more already-enrolled enclaves of the network.

14. The method of claim 8, wherein the configuration data is signed by an off-line certifying authority, the method further comprising the new service enclave using a public key of the certifying authority to authenticate the configuration data.

15. The method of claim 1, comprising an already-enrolled service enclave of the plurality of service enclaves receiving new software code and using a public key of an off-line certifying authority to authenticate the new software code before executing the new software code in the already-enrolled service enclave.

16. A computer system comprising an authority service hosted on a first computing device and configured to enroll a new service enclave, of a plurality of service enclaves hosted on one or more computing devices of a network of computing devices, into a set of enrolled service enclaves by:
receiving an identifier of a second computing device, of the network, hosting the new service enclave;
using the identifier of the second computing device to receive, from the second computing device, an attestation of software code stored in the new service enclave;
in response to receiving the attestation, generating a certificate that associates the identifier of the second computing device with a public key of the new service enclave; and
providing the certificate to an already-enrolled service enclave of the plurality of service enclaves.

17. The computer system of claim 16, further comprising the one or more computing devices hosting the plurality of service enclaves, wherein the already-enrolled service enclave is configured to:
use a public key of the authority service to authenticate the certificate; and
use the public key of the new service enclave to send encrypted data to the new service enclave.

18. (canceled)

19. The computer system of claim 16, further comprising a gateway enclave configured to receive, and/or send to a client computing device, an attestation for the authority service and/or each of the set of enrolled service enclaves.

20. The computer system of claim 16, further comprising a gateway enclave configured to receive a service request from a client computing device and, in response to receiving said request, to instruct an already-enrolled enclave to perform the requested service.

21. The computer system of claim 20, wherein the gateway enclave is configured to verify an attestation of the client computing device before instructing the already-enrolled enclave to perform the requested service.

22. (canceled)

23. (canceled)

24. The computer system of claim 16, further comprising at least two computing devices configured to host the plurality of service enclaves, wherein the at least two computing devices have different respective processor architectures and/or computer architectures.

25. A non-transitory computer-readable medium storing instructions which, when executed on a first computing device of a network of computing devices, causes the first computing device to host an authority service configured to enroll a new service enclave, or a plurality of service enclaves hosted on one or more of the computing devices of the network, into a set of enrolled service enclaves by:
receiving an identifier of a second computing device, of the network, hosting the new service enclave;
using the identifier of the second computing device to receive, from the second computing device, an attestation of software code stored in the new service enclave;
in response to receiving the attestation, generating a certificate that associates the identifier of the second computing device with a public key of the new service enclave; and
providing the certificate to an already-enrolled service enclave of the plurality of service enclaves.
